(19) United States
(12) Patent Application Publication
(10) Pub. No.: US 2013/0313385 A1
(43) Pub. Date: Nov. 28, 2013

(54) LEVELING ASSEMBLY FOR AN APPLIANCE

(71) Applicants: Adam Raymond Mora, La Grange, KY (US); Christopher Gregory Hoppe, Louisville, KY (US)

(72) Inventors: Adam Raymond Mora, La Grange, KY (US); Christopher Gregory Hoppe, Louisville, KY (US)

(73) Assignee: GENERAL ELECTRIC COMPANY, Schenectady, NY (US)

(21) Appl. No.: 13/477,241

(22) Filed: May 22, 2012

(51) Int. Cl. F16M 11/24; D06F 39/00

(52) U.S. Cl. 248/188.4

(57) ABSTRACT

A leveling assembly for an appliance is provided. The leveling assembly includes a clench nut mounted to the appliance and a jam nut. The clench nut and the jam nut each have a knurled surface. A leveling leg is threaded through the clench nut and the jam nut such that the knurled surfaces of the clench nut and jam nut are facing. The knurled surfaces of the clench nut and jam nut can engage one another to lock the leveling leg in position by impeding rotation of the leveling leg.

### FIELD OF THE INVENTION

The present subject matter relates generally to leveling assemblies for appliances, e.g., washing machine appliances or pedestals for washing machine appliances.

### BACKGROUND OF THE INVENTION

In order to operate efficiently, a washing machine appliance is preferably arranged in a level configuration. For example, a vertical axis washing machine appliance is preferably arranged such that a wash basket mounted within a cabinet of the appliance rotates about a vertical axis in the level configuration. Operating a washing machine appliance in an out-of-level configuration can cause the appliance to vibrate in a loud and bothersome manner and potentially damage the appliance. Similarly, operating the washing machine in an out-of-level configuration can cause the appliance to “walk” out of place.

To facilitate adjusting the appliance to a level configuration, washing machine appliances are generally provided with features for leveling the appliance. For example, feet mounted to a bottom of the appliance can support the appliance. Also, such feet can adjust in height in order to level the appliance. However, over time, the feet can vibrate loose or out of position causing the washing machine appliance to operate out-of-level with the associated drawbacks described above.

Accordingly, a leveling assembly for a washing machine appliance with features for more securely leveling the washing machine appliance would be useful. In particular, a leveling assembly for a washing machine appliance with features for hindering the leveling assembly from vibrating out of a level configuration would be useful.

### BRIEF DESCRIPTION OF THE INVENTION

The present subject matter provides a leveling assembly for an appliance. The leveling assembly includes a clench nut mounted to the appliance and a jam nut. The clench nut and the jam nut each have a knurled surface. A leveling leg is threaded through the clench nut and the jam nut such that the knurled surfaces of the clench nut and jam nut are facing. The knurled surfaces of the clench nut and jam nut can engage one another to lock the leveling leg in position by impeding rotation of the leveling leg. Aspects and advantages of the invention will be set forth in part in the following description, or may be apparent from the description, or may be learned through practice of the invention.

In a first exemplary embodiment, an appliance is provided. The appliance includes a cabinet that extends between a top and a bottom along a vertical direction. A clench nut is attached to the cabinet at the bottom of the cabinet. The clench nut has a knurled surface. The knurled surface of the clench nut faces downwardly along the vertical direction. A jam nut also has a knurled surface. The knurled surface of the jam nut faces upwardly along the vertical direction. A leveling leg has a foot at a distal end of the leveling leg. The leveling leg is threaded through the clench nut and the jam nut such that the jam nut is disposed between the clench nut and the foot of the leveling leg.

In a second exemplary embodiment, a leveling assembly for an appliance is provided. The leveling assembly includes a clench nut configured to be attached to the appliance. The clench nut has a knurled surface. A jam nut also has a knurled surface. A leveling leg has a foot at a distal end of the leveling leg. The leveling leg is threaded through the clench nut and the jam nut such that the jam nut is disposed between the clench nut and the foot of the leveling leg. The clench nut and the jam nut are disposed on the leveling leg such that the knurled surface of the clench nut faces the knurled surface of the jam nut.

In a third exemplary embodiment, a pedestal for supporting an appliance is provided. The pedestal includes a housing that extends between a top and a bottom along a vertical direction. A clench nut is attached to the housing at the bottom of the housing. The clench nut has a knurled surface. The knurled surface of the clench nut faces downwardly along the vertical direction. A jam nut also has a knurled surface. The knurled surface of the jam nut faces upwardly along the vertical direction. A leveling leg has a foot at a distal end of the leveling leg. The leveling leg is threaded through the clench nut and the jam nut such that the jam nut is disposed between the clench nut and the foot of the leveling leg.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an exemplary washing machine appliance supported by an exemplary pedestal according to an embodiment of the present subject matter.

FIG. 2 is a perspective view of the washing machine appliance of FIG. 1.

FIG. 3 is a perspective view of the pedestal of FIG. 1.

FIG. 4 illustrates a side cross-sectional view of the exemplary washing machine appliance of FIG. 1.

FIG. 5 provides a partial, cross-sectional view of the pedestal of FIG. 1 illustrating a leveling assembly according to an exemplary embodiment of the present subject matter supporting the pedestal.

FIG. 6 provides a partial, cross-sectional view of the washing machine appliance of FIG. 2 illustrating another leveling assembly according to an exemplary embodiment of the present subject matter supporting the washing machine appliance.

FIG. 7 illustrates a cross-sectional view of an exemplary embodiment of a jam nut of the leveling assembly of FIG. 5 taken along the 7-7 line of FIG. 8.

FIG. 8 illustrates a bottom view of the jam nut of the leveling assembly of FIG. 5 and particularly illustrates an exemplary knurled surface of the jam nut.

FIG. 9 provides a cross-sectional view of an exemplary embodiment of a clench nut of the leveling assembly of FIG. 5 taken along the 9-9 line of FIG. 10.

FIG. 10 provides a bottom view of the clench nut of the leveling assembly of FIG. 5 and particularly illustrates an exemplary knurled surface of the clench nut.

FIGS. 11 and 12 illustrate a partial, side views of the interaction between the knurled surface of the clench nut and the jam nut of the leveling assembly of FIG. 5.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

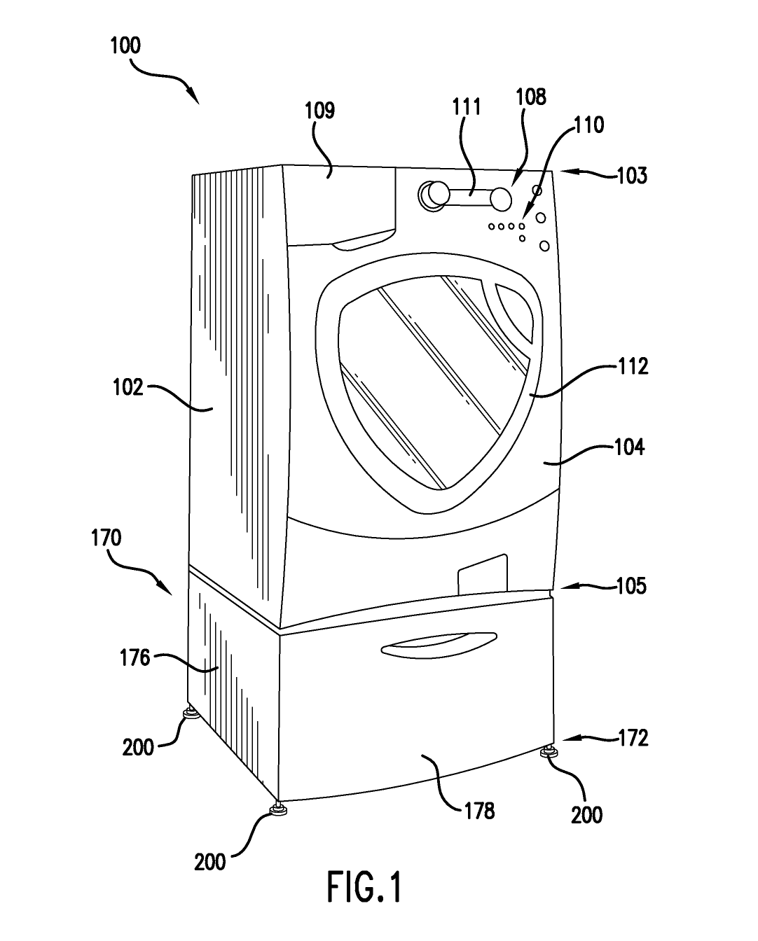

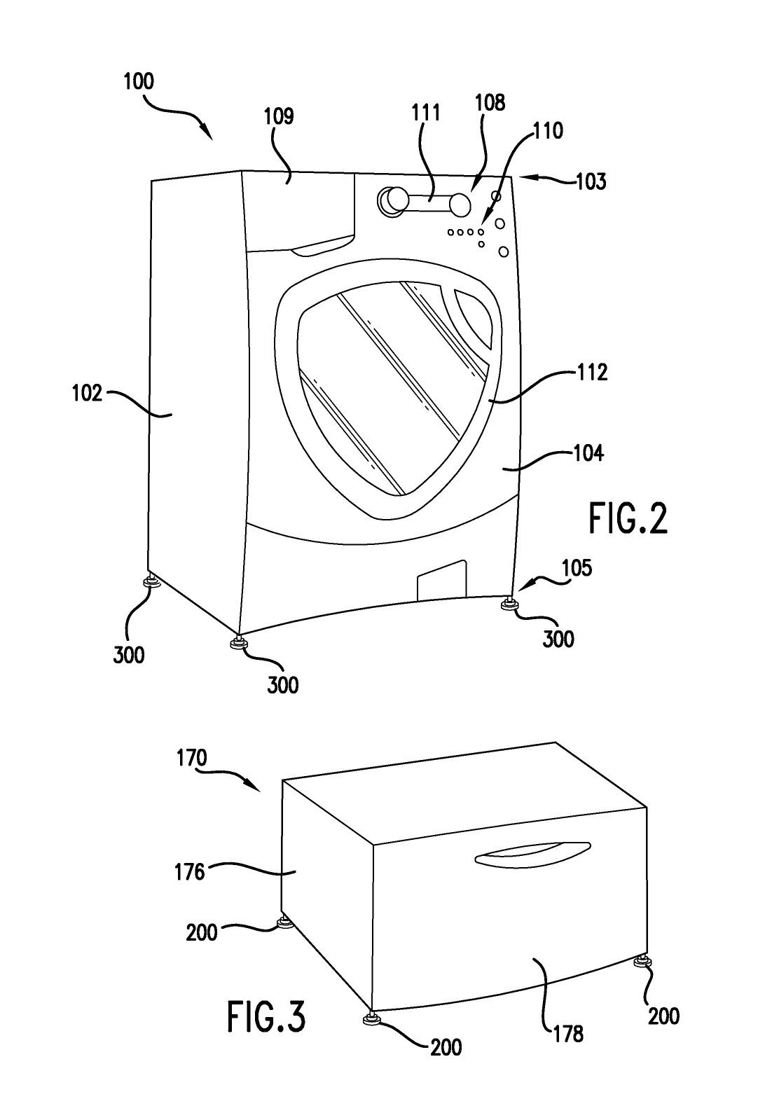

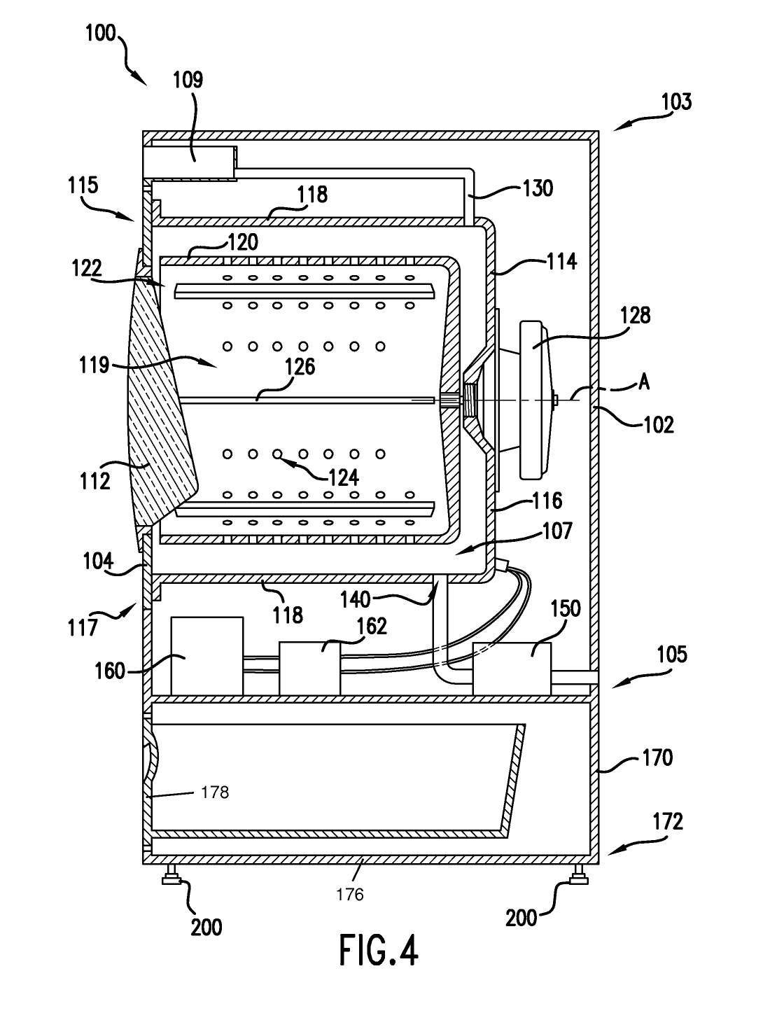

FIG. 1 is a perspective view of an exemplary horizontal axis washing machine 100 mounted on an exemplary pedestal 170. FIG. 2 illustrates washing machine appliance 100 removed from pedestal 170. FIG. 3 illustrates a perspective view of pedestal 170. FIG. 4 is a side cross-sectional view of washing machine appliance 100.

Turning now to FIGS. 1 and 4, washing machine appliance 100 includes a cabinet 102. Cabinet 102 extends between a top 103 and a bottom 105. Cabinet also includes a front panel 104. A door 112 is mounted to front panel 104 and is rotatable about a hinge (not shown) between an open position (not shown) facilitating access to a wash tub 114 (FIG. 4) located within cabinet 102, and a closed position (FIG. 1) prohibiting access to wash tub 114. Pedestal 170 is positioned beneath bottom 105 of cabinet 102 and includes a housing 176 that receives a storage drawer 178. Washing machine appliance 100 is mounted to pedestal 170 such that pedestal 170 supports washing machine appliance 100.

A control panel 108 including a plurality of input selectors 110 is coupled to front panel 104. Control panel 108 and input selectors 110 collectively form a user interface input for operator selection of machine cycles and features. For example, in one embodiment, a display 111 indicates selected features, a countdown timer, and/or other items of interest to machine users.

Referring now to FIG. 4, washing machine appliance 100 includes wash tub 114 that defines a wash chamber 119 configured for receipt of a washing fluid. Thus, wash tub 114 is configured for containing washing fluid. Washing fluid disposed in wash tub 114 may include, e.g., water, fabric softener, bleach, and/or detergent. Wash tub 114 includes a back wall 116 and a sidewall 118 and also extends between a top 115 and a bottom 117. A pump assembly 150 is located beneath tub 114 for gravity assisted flow when draining tub 114. Pump assembly 150 is also configured for recirculating washing fluid within wash tub 114.

A basket 120 is rotatably mounted within wash tub 114 in a spaced apart relationship from tub sidewall 118 and the tub back wall 116. Basket 120 defines an opening 122 for receiving for washing. Basket also 120 defines a plurality of perforations 124 in order to facilitate fluid communication between an interior of basket 120 and wash tub 114. A sump 107 is defined by wash tub 114 at bottom 117 of wash tub 114. Sump 107 is configured for receipt of washing fluid during operation of appliance 100. For example, during operation of appliance 100, washing fluid may be urged by gravity from basket 120 to sump 107 through plurality of perforations 124.

A spout 130 is configured for directing a flow of fluid into wash tub 114. Spout 130 may be in fluid communication with a water supply (not shown) in order to direct fluid (e.g., clean water) into wash tub 114. Spout 130 may also be in fluid communication with the sump 107. For example, pump assembly 150 may direct washing fluid disposed in sump 107 to spout 130 in order to circulate washing fluid in wash tub 114.

A motor 128 is in mechanical communication with basket 120 in order to selectively rotate basket 120, e.g., during an agitation or a rinse cycle of washing machine appliance 100 as described below. Ribs 126 extend from basket 120 into wash chamber 119. Ribs 126 assist agitation of articles disposed within wash chamber 119 during operation of washing machine appliance 100. For example, ribs 126 may lift articles disposed in basket 120 during rotation of basket 120.

A detergent drawer 109 is slidably mounted within front panel 104. Detergent drawer 109 receives a fluid additive (e.g., detergent, fabric softener, bleach, or any other suitable liquid) and directs the fluid additive to wash chamber 119 during operation of appliance 100. Additionally, a reservoir 160 is disposed within cabinet 102. Reservoir 160 is also configured for receipt of fluid additive for use during operation of washing machine appliance 100 (shown in FIG. 1). Reservoir 160 is sized such that a volume of fluid additive sufficient for a plurality or multitude of wash cycles of appliance 100 (e.g., five, ten, twenty, fifty, or any other suitable number of wash cycles) may fill reservoir 160. Thus, for example, a user can fill reservoir 160 with fluid additive and operate appliance 100 for a plurality of wash cycles without refilling reservoir 160 with fluid additive. A reservoir pump 162 is configured for selective delivery of the fluid additive from reservoir 160 to wash tub 114.

Operation of washing machine appliance 100 is controlled by a controller or processing device (not shown), that is operatively coupled to control panel 108 (FIG. 1) for user manipulation to select washing machine cycles and features. In response to user manipulation of control panel 108, the controller operates the various components of washing machine appliance 100 to execute selected machine cycles and features.

In an illustrative embodiment, laundry items are loaded into wash basket 120, and washing operation is initiated through operator manipulation of input selectors 110. Wash tub 114 is filled with water and detergent to form a wash fluid. One or more valves (not shown) can be controlled by washing machine appliance 100 to provide for filling wash tub 114 to the appropriate level for the amount of articles being washed. Once wash tub 114 is properly filled with fluid, the contents of wash basket 120 are agitated with ribs 126 for cleansing of laundry items in basket 120.

After the agitation phase of the wash cycle is completed, wash tub 114 is drained. Laundry articles can then be rinsed by again adding fluid to wash tub 114, depending on the particulars of the cleaning cycle selected by a user, ribs 126 may again provide agitation within wash chamber 119. One or more spin cycles may also be used. In particular, a spin cycle may be applied after the wash cycle and/or after the rinse cycle in order to wring wash fluid from the articles being washed. During a spin cycle, basket 120 is rotated at relatively high speeds.

While described in the context of a specific embodiment of horizontal axis washing machine appliance 100, using the teachings disclosed herein it will be understood that horizontal axis washing machine appliance 100 is provided by way of example only. Other washing machine appliances having different configurations, different appearances, and/or different features may also be utilized with the present subject matter as well, e.g., vertical axis washing machine appliances. In addition, the teachings disclosed herein may be used with other appliances as well, e.g., a dishwasher appliance or a refrigerator appliance.

In FIG. 1, washing machine appliance 100 is mounted on top of pedestal 170. Leveling assemblies 200 are mounted at a bottom 172 of pedestal 170. Leveling assemblies 200 are configured for supporting pedestal 170 and, in turn, washing machine appliance 100. Leveling assemblies 200 are also configured for leveling washing machine appliance 100. For example, each leveling assembly 200 is configured to independently adjust in height. Thus, when pedestal 170 rests on an uneven surface, each leveling assembly 200 can be adjusted so that washing machine appliance 100 is arranged in a level configuration as described in greater detail below. As may be seen in FIG. 2, leveling assemblies 300 can also be mounted to washing machine appliance 100 when washing machine appliance 100 is not supported by pedestal 170.

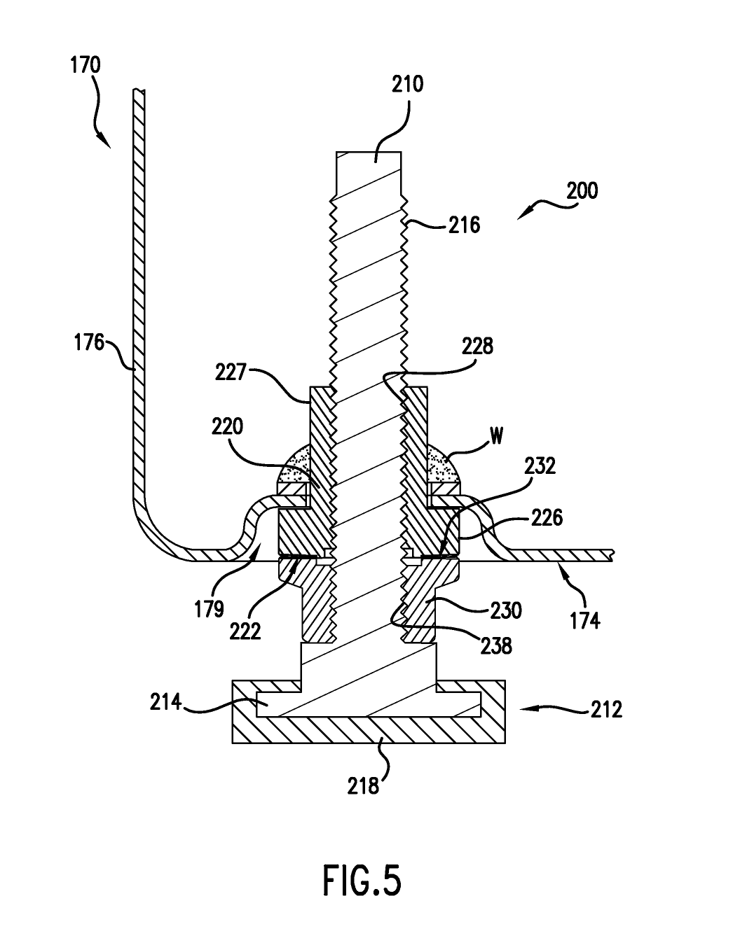

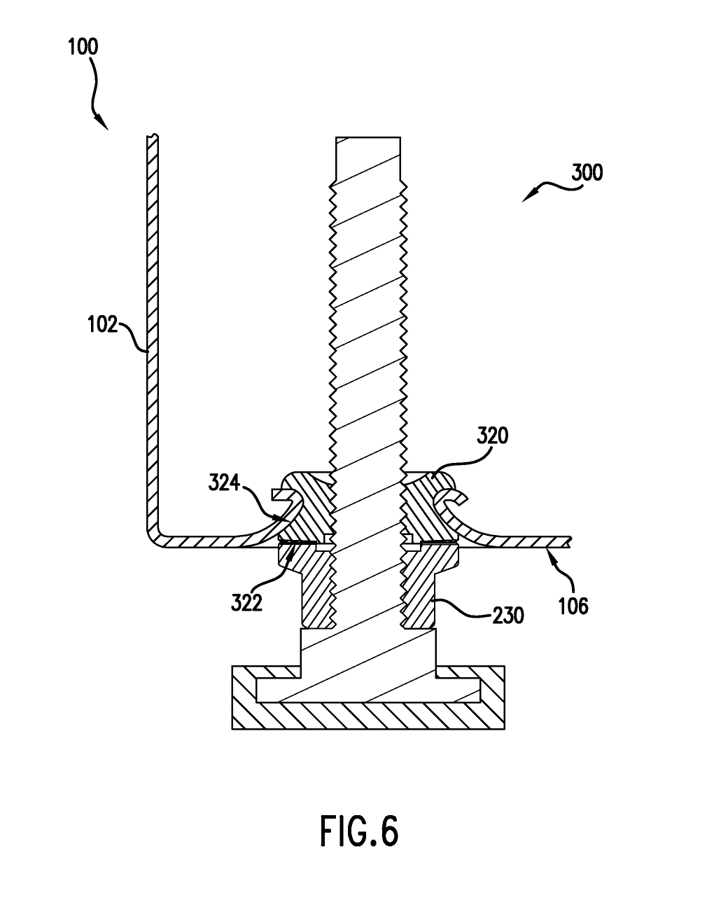

FIGS. 5 and 6 illustrate two exemplary embodiments of a leveling assembly. In particular, FIG. 5 provides a partial, cross-sectional view of pedestal 170 of FIG. 1 with leveling assembly 200 supporting pedestal 170. FIG. 6 provides a partial, cross-sectional view of washing machine appliance 100 of FIG. 2 with leveling assembly 300 supporting washing machine appliance 100.

As shown in FIG. 5, leveling assembly 200 includes a clench nut 220. Clench nut 220 is fixed or mounted to housing 176 of pedestal 170. In particular, clench nut 220 is welded to housing 176 (shown as W). A shaft 227 of clench nut 220 extends though housing 176 and is welded to housing 176 to fix clench nut 220 to pedestal 170. In addition, housing 176 defines a cavity 179 that receives a flange 226 of clench nut 220. Thus, a knurled surface 222 of clench nut 220 is disposed flush with a bottom surface 174 of housing 176. Knurled surface 222 of clench nut 220 is discussed in greater detail below.

Leg 210 is threaded through clench nut 220 to mount leg 210 to housing 176. Thus, threads 216 of leg 210 engage with threads 228 of clench nut 220 to secure leg 210 to housing 176. Leg 210 has a distal end 212. A foot 214 is mounted to the distal end 212 of leg 210. Foot 214 is configured for engagement with a support surface (e.g., flooring). Thus, foot 214 may rest on the support surface in order to support washing machine appliance 100. Foot 214 may also include a pad 218. Pad 218 may be constructed of a softer material than foot 214 (e.g., a plastic). Pad 218 can assist in preventing foot 214 from slipping on or scratching the support surface.

Leg 210 may be rotated in order to selectively adjust the position of foot 214 relative to bottom surface 174 of housing 176. As an example, from the position shown in FIG. 5, leg 210 may be rotated in order to position foot 214 further from bottom surface 174 of housing 176. As discussed above, by selecting the position of foot 214 relative to bottom surface 174 of housing 176, washing machine appliance 100 (FIG. 1) can be adjusted to a level configuration.

Leveling assembly 200 further includes a jam nut 230, e.g., a hex flange nut. Jam nut 230 is threaded onto leg 210. In particular, threads 238 of jam nut 238 engage threads 216 of leg 210. Jam nut 230 is disposed between foot 214 of leg 210 and clench nut 220.

Jam nut 230 may cooperate with clench nut 220 to lock foot 214 in a particular position. As an example, when foot 214 is suitably positioned away from bottom surface 174 of housing 176 to arrange washing machine appliance 100 in the level configuration, jam nut 230 may be urged against clench nut 220 by rotating jam nut 230 up against clench nut 220. In such a configuration, clench nut 220 and jam nut 230 assist in preventing leg 210 from rotating. Further, a knurled surface 232 of jam nut 230 may be placed immediately adjacent (e.g., on or in contact with) knurled surface 222 of clench nut 220. As discussed in greater detail below, such a configuration can prevent jam nut 230 from rotating away from clench nut 220 and thereby permit leg 210 to rotate out of the level configuration, e.g., due to vibrations during operation of washing machine appliance 100. Knurled surface 222 of jam nut 220 and knurled surface 232 of clench nut 230 may have any suitable pattern, e.g., a linear radial pattern as described below, a diamond pattern, an annular ring pattern, or an arcuate radial pattern, such that clench nut 220 and jam nut 230 can engage one another to assist in preventing leg 210 from rotating.

Turning to FIG. 6, leveling assembly 300 is substantially similar to leveling assembly 200. Like leveling assembly 200, leveling assembly 300 includes a clench nut 320 that is mounted to cabinet 102 of washing machine appliance 100. However, rather than being welded to cabinet 102, clench nut 320 defines a recess 324 that receives a portion of cabinet 102. As an example, clench nut 320 can be pressed into cabinet 102 until the portion of cabinet 102 around clench nut 320 curls into recess 224. In such a configuration, clench nut 320 is securely fixed to cabinet 102 such that a knurled surface 322 of clench nut 320 is disposed flush with a bottom surface 106 of cabinet 102.

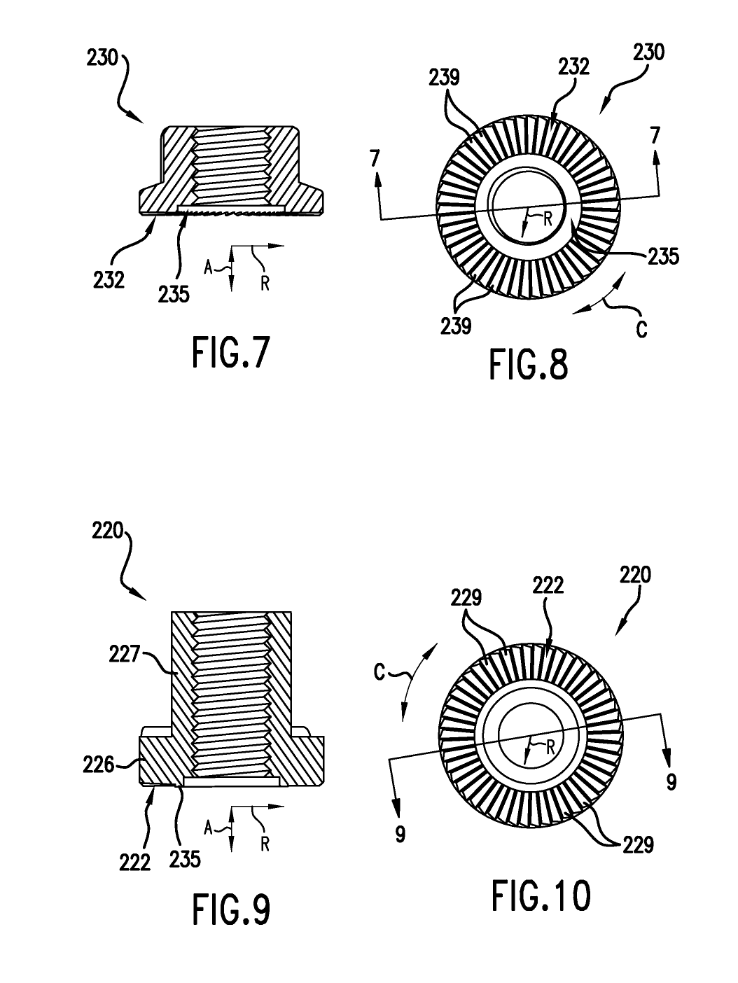

FIG. 7 illustrates a cross-sectional view of jam nut 230. FIG. 8 illustrates a bottom view of jam nut 230 and particularly illustrates knurled surface 232 of jam nut 230. Jam nut 230 has an axial direction A, a radial direction R, and a circumferential direction C.

Jam nut 230 includes a plurality of teeth 239 on knurled surface 232 of jam nut 230. As may be seen in FIG. 8, each tooth of plurality of teeth 239 of jam nut 230 extends across knurled surface 232 in the radial direction R. Also, plurality of teeth 239 of jam nut 230 are (e.g., uniformly) distributed on knurled surface 232 of jam nut 230 about the circumferential direction C. Each tooth of plurality of teeth 239 of jam nut 230 also extends downwardly from knurled surface 232 in the axial direction A.

As may be seen in FIG. 7, jam nut 230 also defines a notch 235 that extends into jam nut 230 along the axial direction A. Notch 235 is also positioned adjacent knurled surface 232 of jam nut 230. Notch 235 is configured to receive a portion of clench nut 220 (FIG. 5) as described in greater detail below.

FIG. 9 illustrates a cross-sectional view of clench nut 220. FIG. 10 illustrates a bottom view of clench nut 220 and particularly illustrates knurled surface 222 of clench nut 220. Clench nut 320 may be constructed in similar manner. In particular, knurled surface 322 of clench nut 320 may be the same or substantially similar to knurled surface 222 of clench nut 220. Clench nut 220 has axial direction A, radial direction R, and circumferential direction C.

Like jam nut 230 (FIGS. 7 and 8), clench nut 220 includes a plurality of teeth 229 on knurled surface 222 of clench nut 220. As may be seen in FIG. 10, each tooth of plurality of teeth 229 of clench nut 220 extends across knurled surface 222 in the radial direction R. In addition, plurality of teeth 229 of clench nut 220 are (e.g., uniformly) distributed on knurled surface 222 of clench nut 220 about the circumferential direction C. Each tooth of plurality of teeth 229 of clench nut 220 also extends downwardly from knurled surface 222 in the axial direction A.

As may be seen in FIG. 9, clench nut 220 also includes a projection 225 that extends downwardly and is positioned adjacent knurled surface 222 of clench nut 220. Projection 225 is configured for receipt by notch 235 of jam nut 230 (FIG. 7). Projection 225 can assist in locking jam nut 230 and clench nut 220 together.

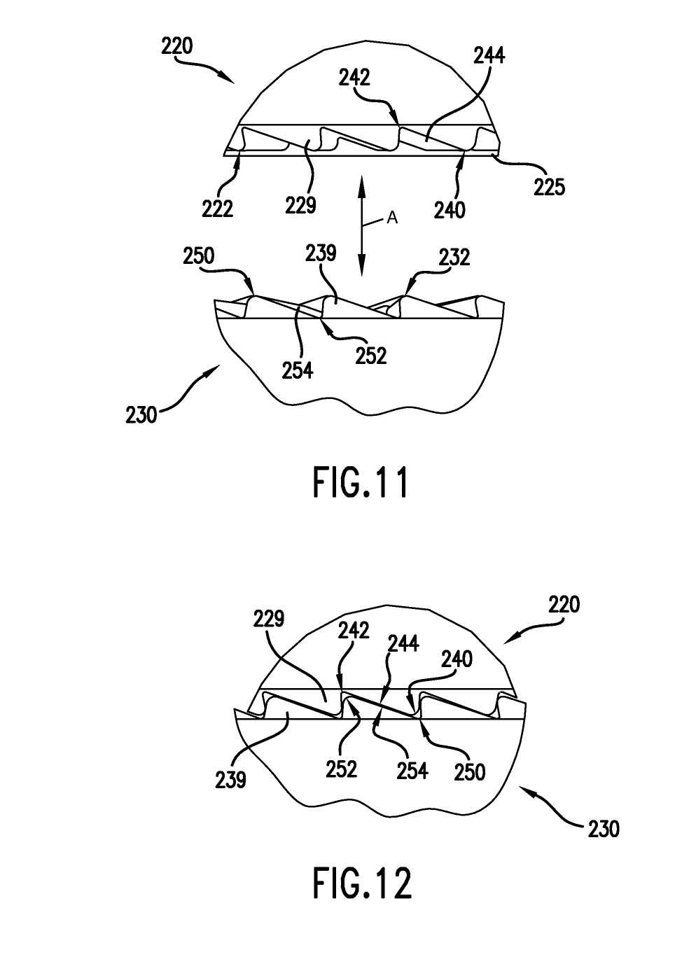

FIGS. 11 and 12 illustrate partial, side views of the interaction between knurled surface 222 of clench nut 220 and knurled surface 232 of jam nut 230. In FIG. 11, knurled surface 222 of clench nut 220 is shown in an exploded configuration relative to knurled surface 232 of jam nut 230. Conversely, in FIG. 12, knurled surface 222 of clench nut 220 engages knurled surface 232 of jam nut 230. As will be understood by those skilled in the art, knurled surface 222 of clench nut 220 can adjust between the configurations shown in FIGS. 11 and 12, e.g., by rotating jam nut 230 on leg 210 (FIG. 5).

As may be seen in FIG. 11, each tooth of plurality of teeth 229 of clench nut 220 includes a distal edge 240 spaced apart from a proximal edge 242 along the axial direction A. Distal edge 240 of clench nut 220 and proximal edge 242 of clench nut 220 extend on knurled surface 222 of clench nut 220 along radial direction R (FIG. 10). A sloped surface 244 extends between and connects distal edge 240 and proximal edge 242 of plurality of teeth 229 of clench nut 220. Similarly, each tooth of plurality of teeth 239 of jam nut 230 includes a distal edge 250 spaced apart from a proximal edge 252 along the axial direction A. Distal edge 250 of jam nut 230 and proximal edge 252 of jam nut 230 extend on knurled surface 232 of jam nut 230 along radial direction R (FIG. 8). A sloped surface 254 extends between and connects distal edge 250 and proximal edge 252 of plurality of teeth 239 of jam nut 230.

As may be seen in FIG. 12, plurality of teeth 229 of clench nut 220 is configured for engaging plurality of teeth 239 of jam nut 230. When plurality of teeth 229 of clench nut 220 engage plurality of teeth 239 of jam nut 230, (1) sloped surface 244 of plurality of teeth 229 of clench nut 220 is positioned immediately adjacent (e.g., on or in contact with) sloped surface 254 of plurality of teeth 239 of jam nut 230, (2) distal edge 240 of plurality of teeth 229 of clench nut 220 is positioned immediately adjacent (e.g., on or in contact with) proximal edge 252 of plurality of teeth 239 of jam nut 230, and (3) proximal edge 242 of plurality of teeth 229 of clench nut 220 is positioned immediately adjacent (e.g., on or in contact with) distal edge 250 of plurality of teeth 239 of jam nut 230.

With knurled surface 222 of clench nut 220 engaging knurled surface 232 of jam nut 230 as shown in FIG. 12, clench nut 220 and jam nut 230 are coupled together such that clench nut 220 and jam nut 230 are hindered from rotating apart, e.g., along the axial direction. As described above, during operation of washing machine appliance 100, leveling assembly 200 and, in turn, jam nut 230 can experience vibrations that urge jam nut 230 to rotate away from clench nut 220. However, knurled surfaces 222 and 232 hinder such rotation, and, thus, assist in maintaining leveling assembly 200 in the level configuration described above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An appliance comprising:
a cabinet extending between a top and a bottom along a vertical direction;
a clench nut attached to said cabinet at the bottom of said cabinet, said clench nut having a knurled surface, the knurled surface of said clench nut facing downwardly along the vertical direction, said clench nut also having a threaded surface;
a jam nut having a knurled surface, the knurled surface of said jam nut facing upwardly along the vertical direction, said jam nut also having a threaded surface;
a leveling leg having a foot at a distal end of said leveling leg, said leveling leg threaded through said clench nut and said jam nut such that said jam nut is disposed between said clench nut and the foot of said leveling leg, said leveling leg also threaded through said clench nut and said jam nut such that the threaded surface of said leveling leg engages the threaded surface of said jam nut and the threaded surface of said clench nut.

2. The appliance of claim 1, wherein the knurled surface of said clench nut is positioned in contact with the knurled surface of said jam nut.

3. The appliance of claim 1, wherein said clench nut defines a recess that receives a portion of said cabinet in order to attach said clench nut to said cabinet.

4. The appliance of claim 1, wherein said clench nut is welded to said cabinet.

5. The appliance of claim 1, further comprising a pad mounted to the foot of said leveling leg.

6. The appliance of claim 1, wherein the knurled surface of said clench nut is pressed against the knurled surface of said jam nut in order to impede rotation of said leveling leg.

7. The appliance of claim 1, wherein the appliance is a washing machine appliance.

8. A leveling assembly for an appliance, the leveling assembly comprising:
a clench nut configured to be attached to the appliance, said clench nut having a knurled surface, said clench nut also having a threaded surface;
a jam nut having a knurled surface, said jam nut also having a threaded surface;
a leveling leg having a foot at a distal end of said leveling leg, said leveling leg threaded through said clench nut and said jam nut such that said jam nut is disposed between said clench nut and the foot of said leveling leg, said clench nut and said jam nut disposed on said leveling leg such that the knurled surface of said clench nut faces the knurled surface of said jam nut, said leveling leg also threaded through said clench nut and said jam nut such that the threaded surface of said leveling leg engages the threaded surface of said jam nut and the threaded surface of said clench nut.

9. The leveling assembly of claim 8, wherein the knurled surface of said clench nut is positioned immediately adjacent the knurled surface of said jam nut.

10. The leveling assembly of claim 8, further comprising an elastic pad mounted to the foot of said leveling leg.

11. The leveling assembly of claim 8, wherein the knurled surface of said clench nut is compressed against the knurled surface of said jam nut in order to impede rotation of said leveling leg.

12. A pedestal for supporting an appliance, the pedestal comprising:
a housing extending between a top and a bottom along a vertical direction;
a clench nut attached to said housing at the bottom of said housing, said clench nut having a knurled surface, the knurled surface of said clench nut facing downwardly along the vertical direction, said clench nut also having a threaded surface;
a jam nut having a knurled surface, the knurled surface of said jam nut facing upwardly along the vertical direction, said jam nut also having a threaded surface;
a leveling leg having a foot at a distal end of said leveling leg, said leveling leg threaded through said clench nut and said jam nut such that said jam nut is disposed between said clench nut and the foot of said leveling leg, said leveling leg also threaded through said clench nut and said jam nut such that the threaded surface of said leveling leg engages the threaded surface of said jam nut and the threaded surface of said clench nut.

13. The pedestal of claim 12, wherein the knurled surface of said clench nut is positioned in contact with the knurled surface of said jam nut.

14. The pedestal of claim 12, wherein said clench nut defines a recess that receives a portion of said housing in order to attach said clench nut to said housing.

15. The pedestal of claim 12, wherein said clench nut is welded to said housing.

16. The pedestal of claim 12, further comprising an elastic pad mounted to the foot of said leveling leg.

17. The pedestal of claim 12, wherein the knurled surface of said clench nut is pressed against the knurled surface of said jam nut in order to impede rotation of said leveling leg.

18. The pedestal of claim 12, wherein the pedestal is configured for supporting a washing machine appliance on the top of said pedestal.
